(19) United States
(12) Patent Application Publication
(10) Pub. No.: US 2022/0414731 A1
(43) Pub. Date: Dec. 29, 2022

(54) SOLAR SALES AND INSTALLATION PARTNER NETWORKING

(71) Applicant: QUATIVA, INC., Hermosa Beach, CA (US)

(72) Inventor: Dallen Gary Gietz, Rancho Palos Verdes, CA (US)

(21) Appl. No.: 17/848,208

(22) Filed: Jun. 23, 2022

Related U.S. Application Data
(60) Provisional application No. 63/214,546, filed on Jun. 24, 2021.

(51) Int. Cl. G06Q 30/06; G06Q 30/00; G06Q 10/06; G06Q 10/10; G06Q 40/02; G06Q 50/06; H02S 20/23

(52) U.S. Cl. CPC G06Q 30/0611; G06Q 30/01; G06Q 10/06398; G06Q 10/1095; G06Q 40/025; G06Q 50/06; H02S 20/23

(57) ABSTRACT

A method for managing sales and installations of solar power systems. The method includes retrieving or accessing, by a processor, homeowner information corresponding to a homeowner of a home within a geographical area; receiving, by an input device of a user device, parameters corresponding to a potential solar installation at the home; selecting, by the processor, a preferred installer capable of installing a solar installation at the home based on the parameters; determining, by the processor, at least one financing option based on the homeowner information, the preferred installer, and the parameters; and generating, by the processor, a solar installation proposal corresponding to the solar installation at the home that meets the parameters and includes the preferred installer and the at least one financing option.

### CROSS-REFERENCE TO RELATED APPLICATIONS

This application claims the benefit of and the priority of U.S. Provisional Patent Application No. 63/214,546, entitled “SOLAR SALES AND INSTALLATION PARTNER NETWORKING” and filed on Jun. 24, 2021, the entire contents of which is incorporated herein by reference.

### BACKGROUND

### Field

This disclosure relates to providing a system, method, and apparatus for managing sales and installations of solar power systems.

### Description of the Related Art

Conventionally, selling solar power systems and coordinating or managing installation of the solar power systems often require an entity involved in this business or process to learn multiple systems, pay for various subscriptions, and/or juggle multiple log-ins. Moreover, the foregoing effort may be limited by the EPC (Engineering, Procurement, and Construction)'s geographical footprint and/or procurement schedule. Because of such requirements and/or limitations, improved systems and methods for managing solar power system sales and installation are desired.

### SUMMARY

Examples of the present disclosure may be directed to a system, method, and/or apparatus for managing solar power system sales and/or installation. In various embodiments, described herein is a method for managing sales and installations of solar power systems. The method includes retrieving or accessing, by a processor, homeowner information corresponding to a homeowner of a home within a geographical area; receiving, by an input device of a user device, parameters corresponding to a potential solar installation at the home; selecting, by the processor, a preferred installer capable of installing a solar installation at the home based on the parameters; determining, by the processor, at least one financing option based on the homeowner information, the preferred installer, and the parameters; and generating, by the processor, a solar installation proposal corresponding to the solar installation at the home that meets the parameters and includes the preferred installer and the at least one financing option.

### BRIEF DESCRIPTION OF THE DRAWINGS

Other systems, methods, features, and advantages of the systems, apparatuses, and methods as disclosed herein will be or will become apparent to one of ordinary skill in the art upon examination of the following figures and detailed description. It is intended that all such additional systems, methods, features, and advantages be included within this description, be within the scope of the present disclosure, and be protected by the accompanying claims. Component parts shown in the drawings are not necessarily to scale, and may be exaggerated to better illustrate the important features of the present disclosure. In the drawings, like reference numerals designate like parts throughout the different views, wherein:

FIGS. 1A, 1B, and 1C are a flowchart illustrating a method for managing sales and installations of solar power systems according to an embodiment of the present disclosure;

FIG. 2 is a flowchart illustrating a method for selecting a solar power system installer according to an embodiment of the present disclosure; and

FIG. 3 is a block diagram illustrating an example system for managing sales and installations of solar power systems according to an embodiment of the present disclosure.

### DETAILED DESCRIPTION

The present disclosure is directed to systems and methods for managing sales of solar power systems (also referred to as “solar” throughout the present disclosure) and matching individual sales with installers who can install the solar power systems. Where used herein, solar power systems may refer to any one or more of solar panels; inverters; batteries; electrical wiring; hardware used to install solar panels, inverters, batteries, or wiring; or any additional or alternative equipment that is useful in converting solar energy into electricity usable in a home or business environment. In a similar manner, the systems and methods herein may be equally applicable to other home devices related or unrelated to solar power systems. For example, the systems and methods may be applicable to new roofs (or to roof upgrades to facilitate improved solar generation), to new heating, ventilation, and air conditioning (HVAC) systems, or the like.

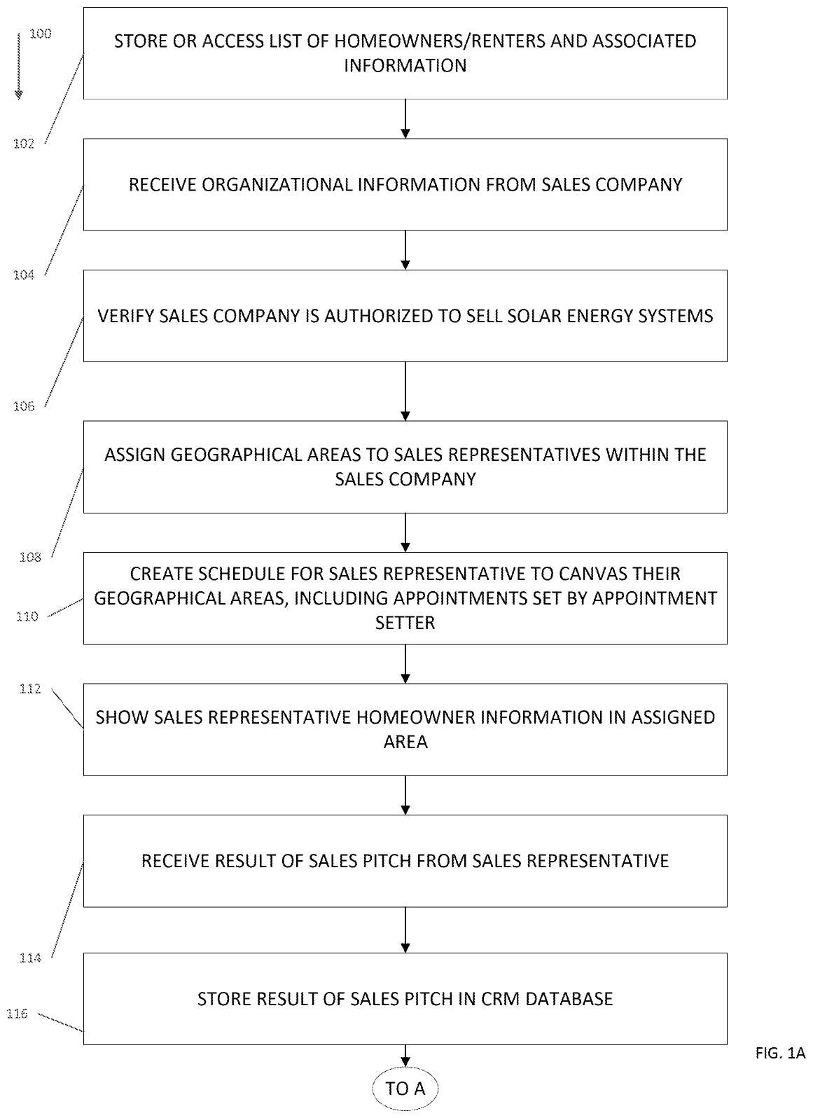

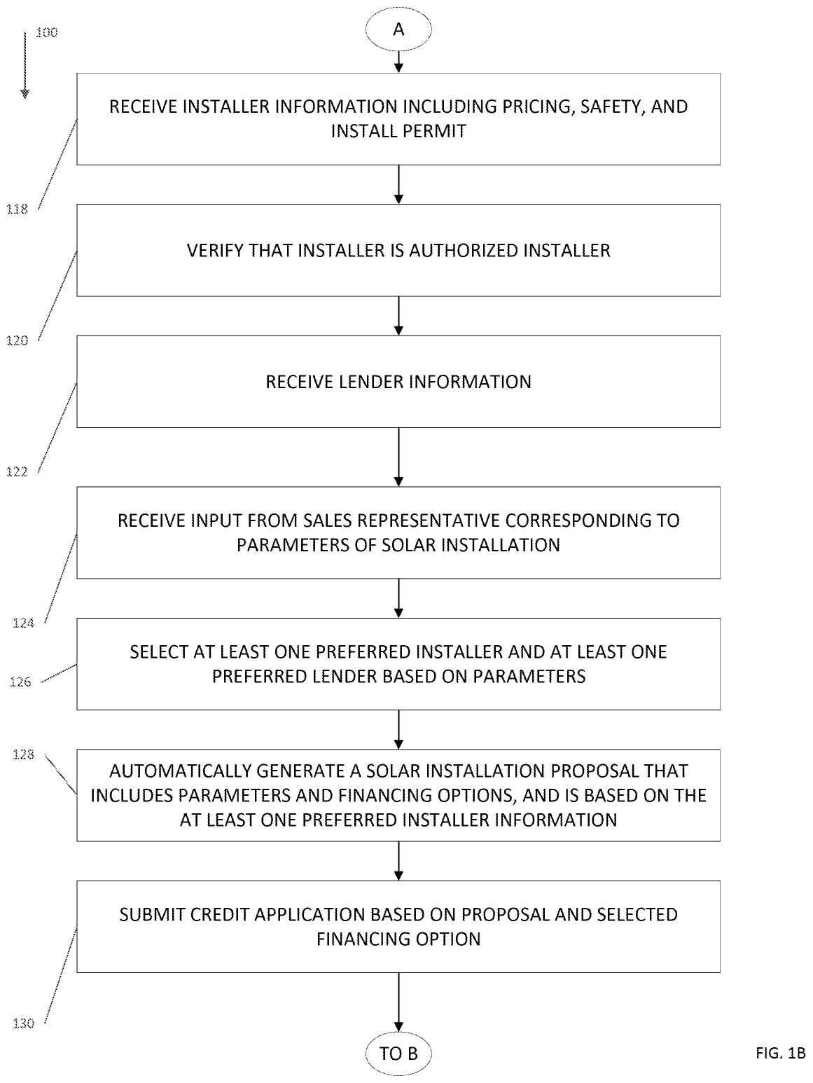

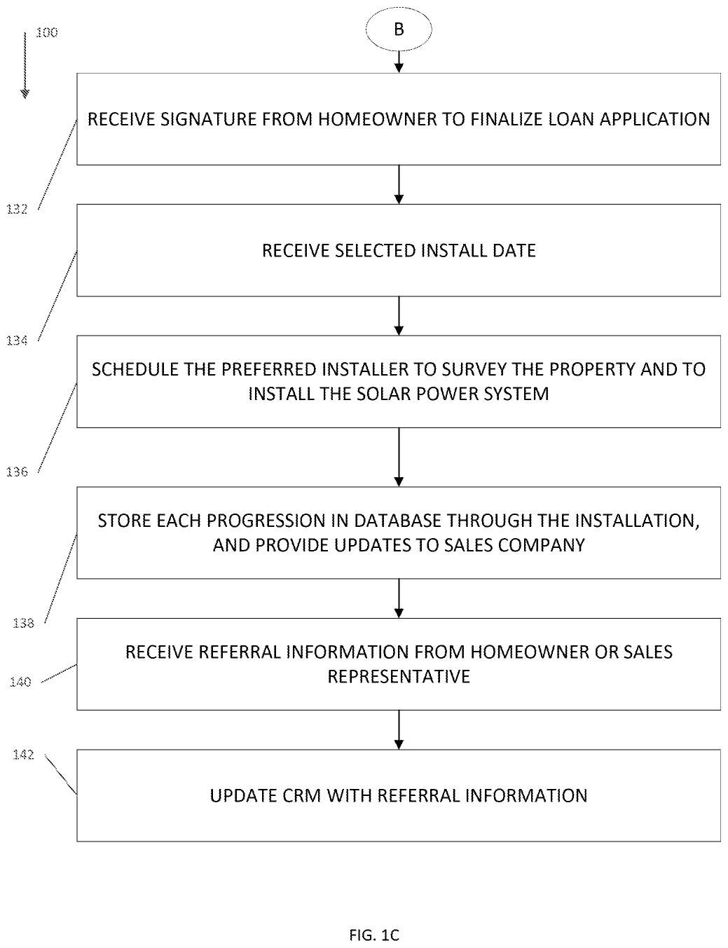

Referring to FIGS. 1A, 1B, and 1C, a method 100 for managing sales of solar power systems from a sales planning phase through a final installation of the solar power system is shown. The blocks of the method 100 may be performed in any order, some blocks may be omitted, and the features of some blocks may be altered without departing from the scope of the present disclosure. The method 100 may be implemented by a system, and may be implemented in software, hardware, or a combination of hardware and software. For example, the system may include a central server and various user devices (e.g., mobile devices that operate an Android or IOS operating system) which may be connected together via a network (such as the internet). The central server may have a processor, a memory, and a network access device. The central server may include one server, a cluster of servers co-located at a single location, a cluster of servers distributed across a geographical area, or any combination thereof. Various user devices (e.g., mobile phones, tablets, laptop or desktop computers, or the like) may each have a processor, a memory, a network access device, and a user interface such as a touchscreen. The user devices may each run one or more application that receives inputs and generates outputs. For example, a first group of user devices may run a sales application that manages sales of the solar power systems, and a second group of user devices may run an installer application that provides information corresponding to a specific installation of a solar power system for installers. The central server may communicate with each of the user devices and may perform some or all operations of the method 100. In various embodiments, each block of the method 100 may be performed by the central server, by a user device, or by both the central server and the user device.

In block 102, the system described herein may retrieve or access a list of home addresses and related information. This information may be retrieved or accessed by the central server (which may include one or multiple servers) or by one or more user devices. For example, the related information may include a name of each resident, whether the resident is a homeowner or a renter, a sales price of the home, contact information for the resident(s), mortgage information corresponding to the home, whether the home already has solar power (and what the system includes, if so), information indicating whether the homeowner has already received a sales pitch for solar power, an address for the home, a home type (e.g., whether the home is a standalone home, an apartment, a condominium, or a townhome), or the like. This information may be retrieved from one or more source such as a public or government database, may be purchased from a private information provider, or the like. In various embodiments, the home addresses and related information may be stored in a memory of at least one of the central server or a user device. In various embodiments, the information may be received or retrieved from multiple sources and the central server may aggregate and store all of the received information into a single database.

In block 104, the system may receive organizational information from a sales company. The information may be provided by the sales company or retrieved from a public or private database. For example, the organizational information may include an organization chart associated with the sales company and may include an overall company (e.g., Company A), one or more organization within the company (e.g., a first sales organization, a second sales organization, and a third sales organization), an identifier of teams within each organization, and a list of sales representatives and appointment setters within each sales team. The organizational information may include information such as geographical areas each company, organization, team, representative, or appointment setter is assigned to. The organizational information may include further information such as commission rates, proposal default costs, or other pricing information. The organizational information may also store or track statistics for each company, organization, team, representative, or appointment setter such as a conversion ratio or other sales metrics, a type of property that each appointment setter has the greatest success with, or the like. The organizational information may be uploaded by a sales company, by an operator of the system, or the like. In various embodiments, the system may determine some or all organizational information based on received information. For example, the system may calculate sales metrics for each representative, organization, sales team, or the like for daily, weekly, monthly, quarterly, and annually.

In block 106, the system may verify whether each sales company is authorized to sell solar energy systems in the geographical area to which they are assigned. For example, the system may access a government list of approved sales companies to ensure that the sales company is fully authorized in each jurisdiction in which they will be making sales. In some situations, each sales representative may also require licensing. In such situations, the system may further determine whether each representative is fully authorized to sell solar systems in their respective jurisdictions.

In some situations, the sales company, organization, team, representative, or appointment setter may be assigned a predetermined geographical area by a supervisor of the group. In some situations, the supervisor may request for the system to assign specific geographical areas to each representative, team, or organization. In such embodiments and in block 108, the system may assign geographical areas to each sales representative, each team, or each organization. The system may make these assignments, for example, to provide an even quantity of houses to each representative. In some embodiments, the system may rank residences by most likely to purchase a solar power system, for example, based on an analysis of data obtained by the system. In such embodiments, the system may assign geographical areas or residences based on a ranking of each representative (i.e., who is most likely to make a sale), the ranking of residences, or the like. For example, the system may first assign appointments to the representative with the highest sales percentage, then the next highest sales percentage, and so forth. In some situations, the system may assign residences based on availability of the homeowner and the work schedule of the representative. Sales representatives may likewise add appointments they set personally to their schedule. Sales representatives may also be able to input scheduled time off such that the schedule takes into account this time off.

In block 110, the system may create a schedule for each sales representative. The schedule may be based on the assignments in block 108, a time in which each representative is available to make sales (e.g., each representative may provide a set of working hours to the system), a geographical location of each residence (e.g., the system may assign a route that allows the representative to reach a maximum quantity of residences per unit of time), the associated information from block 102, and any other information determined by the system (e.g., such as a ranking of likelihood of purchases by each residence). For example, the system may assign a route to a first representative that allows the representative to reach the residences with the greatest likelihood of making a purchase first while also maximizing a quantity of residences that the representative reaches in a day. In various embodiments, the user device associated with the representative may output a map that provides the assigned route of the representative. In some embodiments, the schedule for each sales representative may further be based on follow-up appointments that were set for the representative, whether by the representative, appointment setters, or the like.

In various embodiments, the appointment setters may call each residence in an assigned geographical area to begin the process of selling the solar power systems. In such embodiments, the appointment setters may schedule in-person sales meetings in which a sales representative is to meet with the resident. In such embodiments, the system may assign an ordered list of residences for the appointment setters to call. This ordered list may be based on the information from block 110, for example. Also in such embodiments, the system may assign the routes to the sales representatives based on the in-person sales meetings scheduled by the appointment setters.

A user device associated with a team or company lead may allow the team or company leader to monitor progress of each sales representative and each appointment scheduler. In various embodiments, the system may provide the leader with current locations of the representatives. Similarly, a screen of a user device may be shared with a remote device. For example, a supervisor may monitor the screen of a representative to assist the representative in completing his assigned route, or to assist the representative in finalizing a proposal.

In various embodiments, the system may have gamified features. In that regard, the system may allow representatives to compete with each other on achieving various milestones. For example, badges or other awards may be provided to the first individual to reach a certain milestone. The gamification may also be provided in the form of challenges which may be set by a team leader. Specific individuals may be capable of calling out other individuals for a gamified challenge (e.g., a first representative may challenge another representative to see which will be the first to reach 10 sales).

The system may further provide statistical or other information to the team members. For example, a specific representative may have a target earnings goal for a period of time. The representative may provide the goal to the system, and the system may provide information to the representative that will allow the representative to reach the goal. For example, the system may calculate a quantity of doors that the representative needs to knock on each day to reach the goal based on determined statistics corresponding to the representative.

In block 112, the user device associated with a sales representative may output information associated with each residence before the representative begins an in-person meeting with the resident. For example, this information may include names of the residents, a sales price of the residence, whether the residence has any installed solar power systems, whether the residence has an associated mortgage and an amount of the mortgage, or any other relevant information that the representative may use to tailor a pitch to the resident.

After pitching the solar power systems to the resident, the sales representative may provide results of the sales pitch to the user device in block 114, which may then provide the results to the central server. For example, the results of the pitch may include an interest level of the resident, whether a follow-up meeting has been scheduled, or the like. This information may be saved in the central server and used when scheduling future routes and appointments. For example, if the resident appeared interested but did not have time to pursue purchase of a solar power system, the system may make a note for an appointment setter to reach back out to the resident in a predetermined quantity of days to schedule an in-person sales pitch. As another example, the server may store information such as whether a residence was unoccupied during a visit by a sales representative.

The system may store information corresponding to progress of each sales representative. For example, the system may store and organize information indicating which doors the representative has knocked on, a duration between successive door knocks, or the like.

In block 116, the server may save the results of the sales pitch from block 114 in a customer relationship management (CRM) database. The CRM database may be used by the server or by a user device when planning future sales pitches. For example, the CRM database may further receive and store referrals provided by a resident. The CRM may further store information such as which residences have received a sales pitch, percentage completion of each assigned area, any notes input by a representative or appointment setter, or the like.

In various embodiments, the system may be capable of updating stored information based on changes in a specific geographical location and notifying user devices accordingly. For example, the server may learn when a new resident has moved to a residence. The server may transmit a notification to a user device associated with a representative responsible for the location such that the representative may attempt to sell the new resident.

In block 118, the system may receive installer information corresponding to multiple installers. This information may be stored in the central server. This installer information may include such items as a name or license number of the installer, types of solar power systems the installer is capable of installing, pricing information (including available add-ons such as batteries the installer can provide), a safety score of the installer (e.g., provided by a government server or a private database of safety events), and information corresponding to an installer permit held by the installer. The information may also include a geographical location of the installer, a location the installer can service, a cycle time of the installer (i.e., how long it takes to install a system from first assignment of the system), customer reviews of the installer, reviews of the installer by sales representatives, and peak performance of the installer. The information may further include compatibility information (e.g., types of roofs that are compatible with the installer's solar power systems, types of electrical circuits and other electrical equipment that are compatible with the installer's solar systems, products that are compatible with the installer's solar systems, or the like).

In block 120, the system may verify whether each installer is an authorized installer. For example, the system may do so by comparing some or all information from block 118 to a government database of authorized installers for a specific area.

In block 122, the server may receive or access information corresponding to multiple lenders. For example, the server may receive information such as types of loans offered by the lenders, qualifications each lender requires to provide a loan, interest rates for each type of loan, types of solar power systems each lender is willing to finance, or the like. In some embodiments, the server may also receive information corresponding to fees of the product dealers. This information may be included in the generation of loans, in the generation of pricing to be provided to the customer, or the like.

In block 124, a user device associated with a sales representative may receive input from the representative corresponding to parameters of a specific solar installation for a residence. For example, the parameters may include a desired amount of power generation by the system, a shape of the residence, pitches of the roof, obstructions in the vicinity of the roof (i.e., trees overhanging the roof), whether the residence has any existing solar panels or equipment, a type of electrical system of the residence (including types of equipment the residence has and service panels), or the like. The parameters may further include salary and other financial information of the resident, a down payment amount to be provided by the resident, a desired loan duration, desired types of equipment (e.g., solar panel brands, transformer brands, battery brands), or the like. The information may be provided graphically or textually. For example, the user device may output a representation of the residence and the representative may draw an outline of the solar installation along with any obstructions.

In various embodiments, the system may calculate or otherwise retrieve additional information as parameters. For example, the system may retrieve from a database energy consumption information corresponding to the residence. For example, the system may access a database associated with an energy service provider and determine previous energy usage of the residence. As another example, the sales representative may scan a utility bill from the residence and the server may determine the energy consumption information based on the scanned power bill.

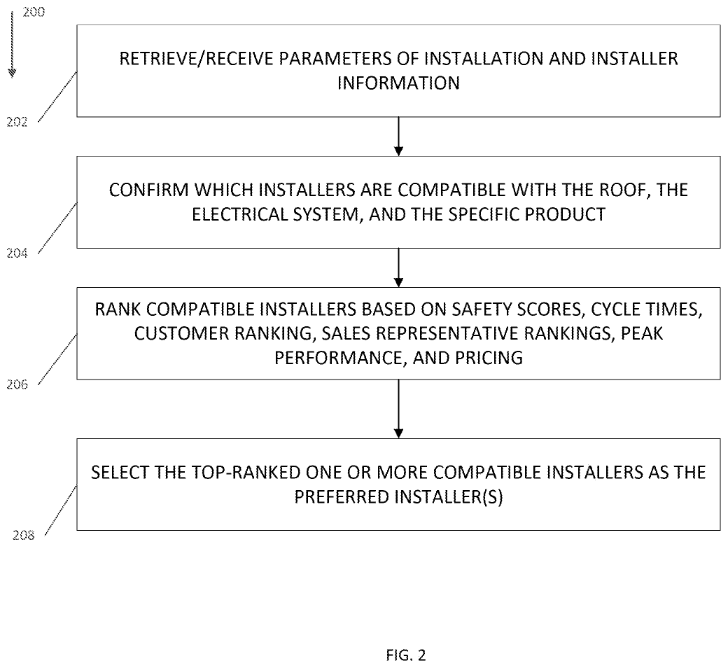

In block 126, the system may select at least one preferred installer and at least one preferred lender. This information may be based on the parameters of block 124 along with other information obtained or known by the system. For example and referring briefly to FIG. 2, the system may select at least one installer based on a number of installer parameters, and may rank the installers based on the parameters (see method 200 shown in FIG. 2). As described herein, the parameters of installation and/or the installer information may be retrieved or received by the system (see block 202). For example, the installer parameters may include whether the installer is approved by each lender, the geographical location of the installer (and in which locations the installer will work), safety scores of the installer, cycle times of the installer, customer reviews, sales representative reviews, peak capacity information, compatibility of the installer's systems with the existing system of the residence, most suitability of the installer for the parameters of the installation, and pricing of the installer. Moreover, the system may confirm which installers are compatible with the given roof, electrical system, and/or the specific product (see block 204). The compatible installers may be ranked based on, e.g., the safety scores, cycle times, customer rankings, sales representative rankings, peak performance, pricing, etc. (see block 206). The top-ranked one or more compatible installers may be selected or identified as the preferred installer(s) (see block 208). For example, the top-ranked preferred installer may be selected as the installer that can provide the desired parameters of the solar installation and that results in a maximum payment to the operator of the system. The lender may be selected in a similar manner. For example, the lenders may be selected based on a match between the lender and preferred installer, based on loan sizes and prices offered by the lender, or the like.

Referring back to FIG. 1, in block 128, the system may automatically generate a proposal (for example, the system may generate a solar installation proposal, or may generate a non-solar proposal such as installation of batteries at the residence). The proposal may include information specific to the residence and may be based on the parameters of block 124, the energy consumption information, the at least one preferred installer, and the at least one preferred lender. The proposal may further include information such as whether a new main service panel will be required. The server may be capable of generating proposals that will both require and not require service panel upgrades. In various embodiments, the proposal may include options for multiple preferred installers or a single preferred installer, various alternative solar power systems or a single system, various lender options or a single lender option, multiple loan types or a single loan type, or the like. The proposal may be automatically generated and output on the user device of the sales representative. In this way, the sales representative may provide the proposal to the resident immediately after inputting the parameters of the installation.

The proposal may be adjustable by the representative. For example, the representative may reorder slides, add their company's logo, provide color and layout preferences, or the like. The proposal may be accessible from the internet such that the proposal or a link to it may be emailed to the resident.

In various embodiments, the proposal may take into account future energy needs of the residence, for example, based on new equipment to be installed by the resident. In that regard, the proposal may include alternative proposals that take into account the future energy need.

In various embodiments, the proposal may include augmented reality features. For example, after a proposal has been generated, the user device may output an augmented reality display which shows the solar panels on the roof of the residence after the installation has been completed. This may assist the representative in finalizing a sale.

In block 130 and after approval by the resident to proceed with the installation, the sales representative may input a credit application to the system using the user device. This credit application may include any information required by the lender such as a salary of the resident, a mortgage amount of the residence, identifying information of the resident (i.e., social security number), or the like. The user device or system may submit the credit application to the preferred lender (or if multiple preferred lenders, to a lender selected by the resident, or to multiple lenders such that multiple financing options are provided, allowing the resident to select an optimal financing option).

In block 132, the user device may receive a signature from the resident that finalizes the credit application. In this way, a full sales cycle of a solar installation (from receiving desirable parameters to selecting and finalizing a loan application) may be performed using the user device within a relatively short period of time. Similarly, the user device may receive a signature to automatically sign for the installer agreement. In some embodiments, the method may further include collecting and storing signatures of the installer and salesperson. These signatures may complete the full sales cycle and represent completion of the agreement.

In block 134, the user device may receive a selected installation date from the sales representative. For example, the system may determine dates that the selected installer is available (e.g., by accessing a calendar of the selected installer, which may be linked to an existing calendar such as Apple Calendar, Outlook, or Google Calendar) and may provide the available installation dates to the user device. The user device may output the available dates such that the resident may select an optimal installation date for the solar panels to be installed. In various embodiments, the dates may further include available dates for a survey of the property by the installer. In that regard, the resident may schedule the residence survey and the installation date of the solar system at the same time.

In block 136, the system may schedule the survey and installation by the installer. For example, the system may add an entry to the calendar of the installer that corresponds to the survey date and another entry that corresponds to the installation date. This information may be provided to a device associated with the installer such that the installer is made aware of such dates. The system may provide additional information to the installer. For example, the system may provide contact information for the resident, a name of a homeowners association (HOA) that the resident belongs to, whether a proposal is required to be approved by the HOA (and a way to submit the proposal to the HOA if so), whether gates or pets are present in the yard, or the like.

In various embodiments, the representative may wish to speak with the installer during the sales pitch. In that regard, the user device of the representative may allow the representative to directly contact the selected installer and ask any questions about the installation.

During the survey and installation process, the installer may utilize a user device to provide updates to the system. For example, the installer may provide results of the survey to the system after the survey is complete, and may provide results of the installation after the installation device. The system may store such progressions or updates in block 138. Similarly, the system may provide information corresponding to these updates to at least one user device associated with the sales representative (or the sales company or organization) such that the representative is made aware of the status of the project.

In some situations, a resident may provide a referral to a sales representative or another user of the system. In such situations, the system may receive and store the referral information. See block 140. The information may include a location of the referral, contact information of the referral, or any other useful information. In block 142, the system may update the CRM database with the referral information.

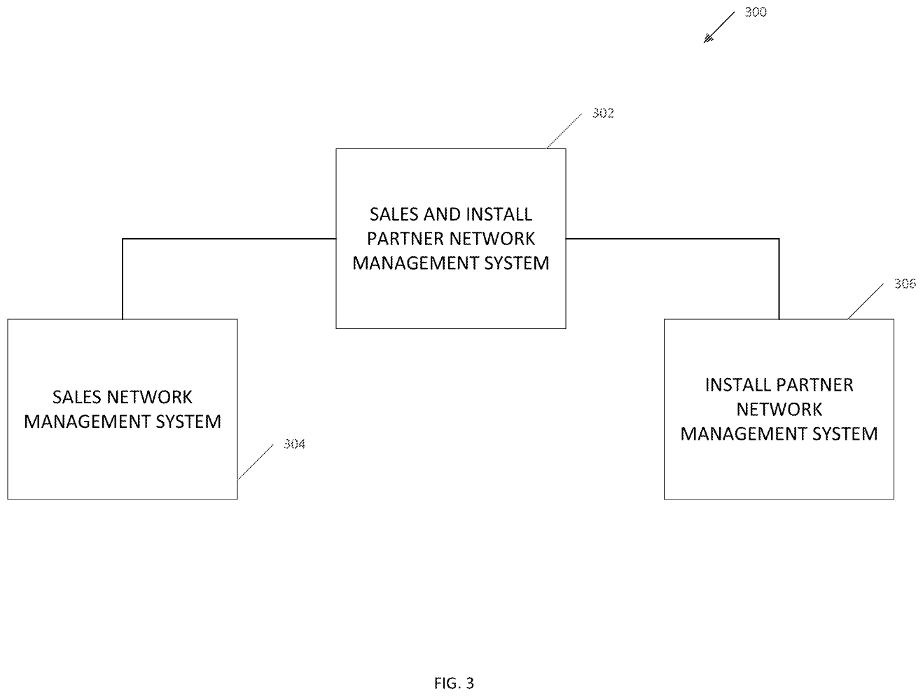

Referring now to FIG. 3, the methods described herein with reference to FIG. 1 may be performed by a system 300 which includes a sales and install partner network management system 302, a sales network management system 304, and an install partner network management system 306. In various embodiments, the various components of the system 300 including the sales and install partner network management system 302, the sales network management system 304, and the install partner network management system 306 may be implemented as a single system or a distributed system including one or more remote devices/servers and/or one or more user devices, etc. and via software and/or hardware configured to perform the various methods described herein. The various components of the system 300 may be communicatively coupled or connected to one another—the communication being performed via one or more wired connections or wirelessly.

In various embodiments, the system 300 (via at least one or more components thereof) may perform a sales partner project verification (e.g., via the sales and install partner network management system 302 and the sales network management system 304). For example, in some embodiments, the system 300 may only deliver ready-to-build projects to installers. That is, the system 300 may verify that financing is approved, financing stipulations are submitted for review, loan document signatures are complete, installer agreement signatures are complete, installer document signatures are complete, and/or utility bills are collected before delivering only those projects that satisfy one or more of the foregoing verifications to the installers.

Furthermore, in various embodiments, the system 300 (via at least one or more components thereof) may perform an install partner project distribution (e.g., via the sales and install partner network management system 302 and the install partner network management system 306). For example, in some embodiments, the system 300 may assign a given project to the most likely installer to deliver the best performance based on one or more of the following conditions—the system 300 may verify whether a given installer is at least one of lender-approved, close to core geography, associated with satisfactory safety scores, associated with satisfactory cycle time scores, associated with satisfactory customer reviews, associated with satisfactory sales representative reviews, associated with the volume being within peak performance capacity, most suitable for project install details (based on, e.g., roof type, pitch, products, electrical, product, etc.), or associated with pricing that is the most advantageous to the business (e.g., related to pricing and adders).

In some embodiments, the system 300 (via at least one or more components thereof—e.g., the sales and install partner network management system 302) may send project enrollment details to install partners, and/or send project milestone updates to sales partners. Furthermore, the system 300 may calculate compensation structure(s) (e.g., commission, a margin for the management service provider, etc.). For example, the commission may be based on a difference between a sales price and a sales rate, and the margin for the management service provider may be based on a difference between the sales rate and an install rate.

Moreover, in some embodiments, the system 300 may include one or more additional components or entities which may perform dynamic workflow tracking of installer project (via, e.g., assigning workflow rule(s), custom building or importing workflows, automating resource assignments, managing resource calendar, automating communications, changing core business flows without developers, etc.). Alternatively or in addition, the system 300 may be part of another system which centralizes all solar tool/function/systems into one system—including, e.g., canvassing, CRM tracking, scheduling, proposal building, finance comparisons, credit applications, loan signing, installer signing, survey scheduling, installer handoff, project tracking, referral harvesting, etc.

As referenced throughout, the system may be capable of calculating and providing statistics (which may also include other useful sales or other information which may be calculated using statistics, machine learning, or artificial intelligence). These statistics may correspond to sales statistics of representatives, groups, teams, companies, appointment setters, or the like. The statistics may also correspond to homeowners. For example, the system may calculate a likelihood of a sale to each resident based on previously-detected and currently-provided statistics. The system may then direct sales representatives to residences with a highest likelihood of sales. Likewise, the system may determine statistics corresponding to proposals. For example, the system may provide information to a representative indicating which portions of a specific proposal a resident spent a majority of time looking at so that the representative may tailor future pitches to the specific area of the proposal. Likewise, a team lead may be informed of portions of proposals that were viewed immediately before agreement to a sale so the team lead may inform his representatives to focus on that portion of the proposal during a pitch.

In various embodiments, the system may include or utilize at least one of a machine learning or artificial intelligence component such as a neural network, natural language processing, or Bayesian network capable of performing machine learning or artificial intelligence algorithms. The artificial intelligence algorithm may monitor progress of each sales representative and may make suggestions to increase conversion rates for the representative based on learned information.

In various embodiments, the system may be capable of submitting applications to government agencies based on proposals and matched installers and lenders. For example, in California, installers must be associated with sales representatives in front of the contractors state license board (CSLB). In that regard, the system may submit an application to the CSLB that associates the installer with the representative after receiving notification that a sale is being completed with the representative and the installer.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a payment form and (ii) an address. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); JAVA® 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

For the sake of brevity, conventional data networking, application development, and other functional aspects of the system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C #, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: gift card data, transaction card data, credit card data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by artificial intelligence (AI) or machine learning. Artificial intelligence may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Any communication, transmission, communications channel, channel, and/or the like discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV®, MICROSOFT® XBOX®, ROKU®, AMAZON FIRE®, GOOGLE CHROMECAST™, SONY® PLAYSTATION®, NINTENDO® SWITCH®, etc.) a uniform resource locator (“URL”), a document (e.g., a MICROSOFT® Word™ or EXCEL®, an ADOBE® Portable Document Format (PDF) document, etc.), an “ebook,” an “emagazine,” an application or microapplication (as described herein), an SMS or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUMBLR®, REDDIT®, SNAPCHAT®, WHATSAPP®, FLICKR®, VK®, QZONE®, WECHAT®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

The systems, computers, computer-based systems, and the like disclosed herein may provide a suitable website or other internet-based graphical user interface which is accessible by users. Practitioners will appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf, which is hereby incorporated by reference in its entirety.

In various embodiments, the system and various components may integrate with one or more smart digital assistant technologies. For example, exemplary smart digital assistant technologies may include the ALEXA system developed by AMAZON®, GOOGLE HOME®, APPLE® HOMEPOD®, and/or similar digital assistant technologies. AMAZON® ALEXA, GOOGLE HOME®, and APPLE® HOMEPOD®, may each provide cloud-based voice activation services that can assist with tasks, entertainment, general information, and more. All AMAZON® ALEXA devices, such as the AMAZON ECHO®, AMAZON ECHO DOT®, AMAZON TAP®, and AMAZON FIRE® TV, have access to the ALEXA system. The ALEXA, GOOGLE HOME®, and APPLE® HOMEPOD® systems may receive voice commands via its voice activation technology, and activate other functions, control smart devices, and/or gather information. For example, the smart digital assistant technologies may be used to interact with music, emails, texts, calling, question answering, home improvement information, smart home communication/activation, games, shopping, making to-do lists, setting alarms, streaming podcasts, playing audiobooks, and providing weather, traffic, and other real time information, such as news. The ALEXA, GOOGLE HOME®, and APPLE® HOMEPOD® systems may also allow the user to access information about eligible transaction accounts linked to an online account across all digital assistant-enabled devices.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT and XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. As a further example, representational state transfer (REST), or RESTful, web services may provide one way of enabling interoperability between applications.

In various embodiments, one or more servers discussed herein may include application servers (e.g., WEBSPHERE®, WEBLOGIC®, JBOSS®, POSTGRES PLUS ADVANCED SERVER®, etc.). In various embodiments, the server may include web servers (e.g. Apache, IIS, GOOGLE® Web Server, SUN JAVA® System Web Server, JAVA® Virtual Machine running on LINUX® or WINDOWS® operating systems, etc.).

As will be appreciated by one of ordinary skill in the art, the system or any of its components may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet-based embodiment, an entirely hardware embodiment, or an embodiment combining aspects of the internet, software and hardware. Furthermore, the system may take the form of a computer program product on a computer-readable storage medium (e.g., a non-transitory readable storage medium) having computer-readable program code means embodied in the storage medium. Any suitable computer-readable storage medium may be utilized, including hard disks, CD-ROM, optical storage devices, magnetic storage devices, and/or the like.

The systems and methods are described herein with reference to one or more of screen shots, block diagrams and flowchart illustrations of methods, apparatus (e.g., systems), or computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general-purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

As used herein, “electronic communication” may comprise a physical coupling and/or non-physical coupling capable of enabling system components to transmit and receive data. For example, “electronic communication” may refer to a wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZigBee® protocol maintained by the ZigBee alliance), a cellular protocol, an infrared protocol, an optical protocol, or any other protocol capable of transmitting information via a wired or wireless connection.

As used herein, “transmit” may include sending electronic data from one system component to another over a network connection. Additionally, as used herein, “data” or “information” may include encompassing information such as commands, queries, files, data for storage, and the like in digital or any other form.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for managing sales and installations of solar power systems, the method comprising:
retrieving or accessing, by a processor, homeowner information corresponding to a homeowner of a home within a geographical area;
receiving, by an input device of a user device, parameters corresponding to a potential solar installation at the home;
selecting, by the processor, a preferred installer capable of installing a solar installation at the home based on the parameters;
determining, by the processor, at least one financing option based on the homeowner information, the preferred installer, and the parameters; and
generating, by a processor, a solar installation proposal corresponding to the solar installation at the home that meets the parameters and includes the preferred installer and at the at least one financing option.

2. The method of claim 1, further comprising storing, in a memory, a database of homeowners and corresponding information and homes, the database including the homeowner information of the homeowner.

3. The method of claim 2, further comprising assigning, by the processor, a first plurality of homes of the database to a first sales representative and assigning, by the processor, a second plurality of homes of the database to a second sales representative, the first plurality of homes and the second plurality of homes being assigned based on geographical locations of the homes.

4. The method of claim 3, further comprising:
receiving, by the network access device, scheduled pitch information from at least one appointment setter device, the scheduled pitch information including a location and a time corresponding to a pitch to be given by the first sales representative; and
outputting, by an output device of the user device associated with the first sales representative, calendar information corresponding to a calendar of the first sales representative, the calendar information including the location and the time of the pitch.

5. The method of claim 4, further comprising:
storing, in a memory, a customer relationship management (CRM) database; and
updating, by the processor, the CRM database to include information corresponding to the pitch.

6. The method of claim 1, wherein selecting the preferred installer includes:
identifying, by the processor, a plurality of installers that are compatible with the potential solar installation based on the parameters and information corresponding to the home;
determining, by the processor, a rank for each of the plurality of installers that are compatible with the potential solar installation based on at least one of safety scores, cycle times, customer rankings, sales representative rankings, peak performance, pricing information, and an installer ranking based on comments by at least one of the plurality of installers; and
selecting, by the processor, the preferred installer based on the rank.

7. The method of claim 1, further comprising submitting, by the processor, a credit application for financing of the solar installation based on a selected financing option of the at least one financing option.

8. The method of claim 1, further comprising transmitting, by a network access device, the solar installation proposal to an installer device associated with a preferred installer.

9. The method of claim 8, further comprising:
determining, by the processor, at least one available date and time that the preferred installer is available to install the solar installation;
receiving, by the input device of the user device, a selected date and time of the at least one available date and time for the solar installation to be installed; and
transmitting, by the network access device, a calendar entry corresponding to the solar installation at the selected date and time.

10. The method of claim 9, further comprising:
receiving, from an installer device associated with the preferred installer, update information corresponding to the solar installation; and
outputting, by the output device of the user device, the update information corresponding to the solar installation.
